(19) United States
(12) Patent Application Publication
(10) Pub. No.: US 2023/0323035 A1
(43) Pub. Date: Oct. 12, 2023

(54) HYDROGENPOLYORGANOSILOXANE AND THERMALLY CONDUCTIVE SILICONE COMPOSITION THEREOF

(71) Applicant: WACKER CHEMIE AG, Munich (DE)

(72) Inventors: Shuai TIAN, Shanghai (CN); Arvid KUHN, Burghausen (DE); Heng YANG, Shanghai (CN)

(73) Assignee: Wacker Chemie AG, Munich (DE)

(21) Appl. No.: 18/024,587

(22) PCT Filed: Sep. 7, 2020
(86) PCT No.: PCT/CN2020/113746

§ 371 Date: Mar. 3, 2023

(51) Int. Cl. C08G 77/12; C08G 77/08; C08L 83/04; C08K 3/22

(52) U.S. Cl. CPC C08G 77/12; C08G 77/08; C08L 83/04; C08L 2203/20; C08K 2003/2227; C08K 2201/001; C08K 3/22

(57) ABSTRACT

The present disclosure relates to a hydrogenpolyorganosiloxane of formula X—[SiR¹₂O]ₘ—[SiR¹(CₐH₂ₐ₊₁)O]ₙ—[SiR¹HO]ᵣ—[SiR¹₂]—X where a is an arbitrary integer between 6 and 18, n is an arbitrary number between 0.7 and 30, m is an arbitrary number between 10 and 1500, r is an arbitrary number between 0 and 200, R¹ is independently at each occurrence a C1-C5 alkyl or phenyl, and X represents one or more groups selected from among hydrogen, alkoxy and hydroxyl, and greater than or equal to 60 mol % of X are hydrogen atoms. The hydrogenpolyorganosiloxane can significantly lower the viscosity and improve the flowability of the resulting silicone composition compared with the existing hydrogenpolyorganosiloxanes at the same thermally conductive filler loading, thereby improving the thermal conductivity.

### FIELD OF THE INVENTION

The present disclosure relates to a hydrogenpolyorganosiloxane and a thermally conductive silicone composition thereof.

### BACKGROUND OF THE INVENTION

Over recent years, the electric vehicle industry has rapidly grown. Power batteries are recognized as a key technology for electric vehicles. Since the increasing temperature of power battery modules can lead to deterioration of battery performance, which reduces the safety, reliability and service life of electric vehicles, heat dissipation is crucial for power batteries.

Thermally conductive silicone compositions are commonly used heat dissipation materials. However, the improvement of the thermal conductivity of these compositions usually results from an increase in the amount of fillers blended, which tends to reduce the flowability of the composition and increase the contact resistance of the interfaces between the heating element, dissipation material and heat sink, and increase the bonding thickness, affecting the efficacy of heat dissipation. Therefore, the loading of thermally conductive fillers and the viscosity of organopolysiloxanes blended with fillers are research priorities.

U.S. Pat. No. 664,925B discloses a thermally conductive silicone composition by using specific amounts of organohydrogenpolysiloxanes as crosslinker and chain extender in combination, blending a mixture of aluminum powder and zinc oxide powder, there is obtained a composition which does not lose flexibility with a possible increase in the amount of filler blended and could follow intimately on contact surface with irregularities before curing. Moreover, this patent has disclosed a long-chain alkyl containing organosilane facilitates the wetting of the thermally conductive filler with the silicone component so as to improve the flexibility of the composition. However, it is not ideal to treat the filler surface with a small silane due to an increase of production costs and a possible damage of thermal conductivity caused by the residual silane on the filler surface.

Efforts have also been made to introduce long-chain alkyl groups to organosiloxane components. CN105838079A discloses a thermally conductive silicone grease composition comprising a vinyl silicone oil with long-chain alkyls in Examples 2-4, where the introducing of long-chain alkyls is mainly to slow down the migration speed of vinyl silicone oil in thermal grease and lower the degree of oil bleeding. The issue of the flowability of thermally conductive grease with a high filler loading is not addressed.

### SUMMARY OF THE INVENTION

The present disclosure provides a novel hydrogenpolyorganosiloxane that can significantly lower the viscosity and improve the flowability of the resulting silicone composition compared with the existing hydrogenpolyorganosiloxanes at the same thermally conductive filler loading, which facilitates the filling of tiny gaps, thereby improving the thermal conductivity of the composition. Moreover, thermally conductive silicone compositions comprising the hydrogenpolyorganosiloxane of the present disclosure could achieve a high filler loading in the absence of any filler surface treatment agent, diluent and/or plasticizer so as to avoid the possible damage of thermal conductivity caused by the residual treatment agents on the filler surface and the exuded or volatilized diluents and/or plasticizers.

In the present disclosure, the “structural formula” of the hydrogenpolyorganosiloxane is determined by ¹H NMR spectroscopy (Nuclear Magnetic Resonance) and optional ²Si NMR spectroscopy, unless otherwise specified. In ¹H NMR spectroscopy, hydrogen-bonded atoms and functional groups can be determined by referring to a well-known database and literature; while ²Si NMR is further used to verify or determine hydrogen-bonded atoms and groups that cannot be accurately determined by ¹H NMR spectroscopy. When analyzing the molecular composition of hydrogenpolyorganosiloxane, first the baseline of ¹H NMR spectrum is leveled then the signal peaks of different kinds of hydrogen are integrated to figure out the peak area. In the case when ²Si NMR spectroscopy is required, the signal peak area of different kinds of silicon is determined by the same method, and then the signal peak areas of hydrogen and silicon are converted in proportion to calculate the number of moles of each group unit of the hydrogenpolyorganosiloxane so as to obtain its structural formula. Generally, the structural formula determined by NMR spectroscopy is an average molecular formula. It is true that the structural formula of the hydrogenpolyorganosiloxane of the present disclosure can be determined using a publicly available NMR spectroscopy method. However, in order to obtain high quality NMR spectra to facilitate the analysis of the structural formula of the hydrogenpolyorganosiloxane, preference is given to deuterated chloroform as the test solvent and to tetramethylsilane (TMS)-free chloroform as the internal standard substance for ¹H NMR spectroscopy, as well as to deuterated benzene as the test solvent and to chromium acetylacetonate as the relaxation reagent for ²⁹Si NMR spectroscopy.

In the present disclosure, the term “particle size” refers to the equivalent diameter of particles, that is, the diameter of the homogenous spherical particles having the same or similar volume as the particles to be tested.

In the present disclosure, the term “room temperature” refers to 23±2° C.

The first aspect of the present disclosure provides a hydrogenpolyorganosiloxane of Formula I:

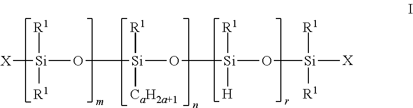

where a is an arbitrary integer between 6 and 18,

n is an arbitrary number between 0.7 and 30,

m is an arbitrary number between 10 and 1500,

r is an arbitrary number between 0 and 200,

R¹ is independently at each occurrence a C1-C5 alkyl or phenyl, and

X represents one or more groups selected from among hydrogen, alkoxy and hydroxyl, and greater than or equal to 60 mol % of X based on the total number of moles of the X groups are hydrogen atoms.

In Formula I, a can be 6, 8, 10, 12, 14, 16 or 18, especially an arbitrary integer between 6 and 16, more especially an arbitrary integer between 6 and 12.

n can be 1, 3, 5, 7, 9, 12, 15, 18, 20, 25 or 30, especially an arbitrary number between 3 and 20, for example between 3 and 15.

m can be 10, 20, 40, 50, 60, 100, 200, 500, 800, 1200 or 1500, especially an arbitrary number between 50 and 500, for example between 55 and 250.

r can be 0, 10, 20, 30, 40, 50, 60, 80, 100, 150 or 200.

R¹ can be a methyl, ethyl, propyl, butyl, pentyl or phenyl, preferably a methyl.

The molar ratio of hydrogen atoms to all X groups is greater than or equal to 60 mol %, especially greater than or equal to 80 mol %. The molar ratio of alkoxy and hydroxyl groups to all X groups is preferably less than or equal to 30 mol %, particularly less than or equal to 20 mol %. An appropriate content of alkoxy and hydroxyl groups contributes to further lowering the viscosity of the composition with a possible increase in the filler loading by interaction with filler, thereby improving the thermal conductivity of the composition. However, hydrogenpolyorganosiloxanes with a too high content of alkoxy and hydroxyl groups may perform worse in storage stability and are likely to bubble when applied to an addition-curable thermally conductive silicone composition which damages the thermal conductivity.

In a preferred embodiment herein, greater than or equal to 60 mol % and less than 100 mol % of X based on the total number of moles of the X groups are hydrogen atoms, and greater than 0 mol % and less than or equal to 30 mol % of X based on the total number of moles of the X groups are alkoxy and hydroxyl groups. In a more particular preferred embodiment herein, greater than or equal to 80 mol % and less than 100 mol % of X based on the total number of moles of the X groups are hydrogen atoms, and greater than 0 mol % and less than or equal to 20 mol % of X based on the total number of moles of the X groups are alkoxy and hydroxyl groups.

In a preferred embodiment herein, the hydrogenpolyorganosiloxane has a structural formula as shown in Formula I, where n is an arbitrary number between 3 and 15, and a, m, r, R¹ and X are as defined above. The hydrogenpolyorganosiloxane with a such range of n is more effective in lowering the viscosity of the composition at a same thermally conductive filler loading. If n is smaller than the aforesaid range, the hydrogenpolyorganosiloxane may be less effective in lowering the viscosity; if n is greater than the aforesaid range, the hydrogenpolyorganosiloxane itself has an obviously increased viscosity and will perform worse in lowering the viscosity of the thermally conductive silicone composition.

The hydrogenpolyorganosiloxane of the present disclosure has a suitable dynamic viscosity at 25° C. of from 10 to 3000 mPa·s. In an embodiment herein, the hydrogenpolyorganosiloxane has a dynamic viscosity at 25° C. of from 10 to 250 mPa·s. In another embodiment herein, the hydrogenpolyorganosiloxane has a dynamic viscosity at 25° C. of from 500 to 2000 mPa·s.

The hydrogenpolyorganosiloxanes of the present disclosure includes a single hydrogenpolyorganosiloxane compound, and a combination of two or more hydrogenpolyorganosiloxane compounds. For each individual hydrogenpolyorganosiloxane molecule, m, n and r are integers within the aforesaid ranges, and, in the X groups, either one listed above accounts for 100%, or one accounts for 50% and another one accounts for 50%; however, for a mixture of two or more different hydrogenpolyorganosiloxane compounds, m, n and r are positive numbers within the aforesaid ranges, which represent an average value, and, in the X groups, percentages of individual ones listed above can be any figure in the range of 0-100%, which represent an average value and the total percentage of all X groups is 100%.

The second aspect of the present disclosure provides a method of preparing the hydrogenpolyorganosiloxane according to the first aspect of the present disclosure, comprising:
a) reacting together a hydroxyl-terminated polysiloxane and at least one organosilicon compound A) selected from among compounds of Formula II and III, and optionally at least one organosilicon compound B) selected from among compounds of Formula IV and V, in the presence of Catalyst 1,

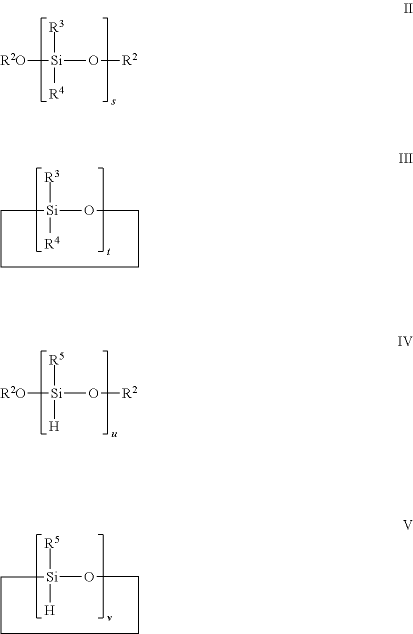

where R² is independently at each occurrence a methyl, ethyl or hydrogen;
R³ is independently at each occurrence a C6-C18 alkyl, for example hexyl, octyl, decyl, dodecyl, tetradecyl, hexadecyl, preferably a C6-C16 alkyl especially a C6-C12 alkyl;
R⁴ is independently at each occurrence a C1-C5 alkyl, for example methyl, ethyl, propyl, butyl, pentyl, preferably methyl;
R⁵ is independently at each occurrence a C1-C5 alkyl, for example methyl, ethyl, propyl, butyl, pentyl, preferably methyl;
s is an arbitrary number between 1 and 20, for example 1, 2, 4, 6, 8, 10, 15, 20;
t is an arbitrary number between 3 and 20, for example 3, 4, 5, 6, 8, 10, 15, 20;
u is an arbitrary number between 1 and 100, for example 1, 20, 30, 40, 50, 60, 80, 100;
v is an arbitrary number between 3 and 100, for example, 3, 4, 5, 6, 8, 10, 20, 50, 80, 100;
b) reacting the product of Step (a) with an endcapper in the presence of Catalyst 2 to give the hydrogenpolyorganosiloxane.

In Step (a), the hydroxyl-terminated polysiloxane is typically of Formula VI:

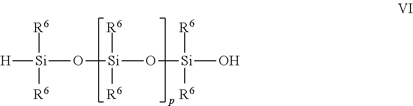

where R⁶ is independently at each occurrence a C1-C5 alkyl for example methyl, ethyl, propyl, butyl and pentyl, or phenyl, preferably methyl;
p is suitably an arbitrary number between 3 and 150, for example an arbitrary number between 10 and 100 especially an arbitrary number between 10 and 60 such as 15, 20, 25, 30, 35, 40, 45, 50, 55. In an embodiment herein, p is an arbitrary number between 15 and 55 especially between 20 and 50.

In Step (a), the reaction comprises a condensation reaction and an equilibration reaction. Condensation and equilibration reactions often take place simultaneously. The reaction of Step a) is carried out suitably at a temperature of from 80° C. to 110° C. especially from 90° C. to 105° C. for a period of suitably from 15 min to 4 h.

The reaction of Step (a) is advantageously carried out at a reduced pressure to extract small molecular alcohols and water generated therefrom, wherein the pressure is reduced below 100 mbar, for example, below 80 mbar.

In Step (a), the organosilicon compound A) can be a dialkoxysilane or linear oligomer thereof of Formula II, or a cyclic oligomer of dialkoxysilane of Formula III.

The latter is more advantageous in obtaining hydrogenpolyorganosiloxanes with multiple long-chain alkyls (23).

The oligomer of Formula II or Ill can be prepared by hydrolytic condensation of a dialkoxysilane, comprising: i) reacting a long-chain alkyl containing dialkoxysilane and water in the presence of Catalyst 3; ii) removing by-products of reaction, water and Catalyst 3. In Step i), the reaction is preferably carried out at a lower temperature, for example at a temperature below 30° C. such as room temperature or temperature below 10° C. considering that the hydrolysis condensation of the dialkoxysilane is an exothermic reaction. The water in Step i) is preferably added dropwise to the long-chain alkyl containing dialkoxysilane considering the reaction is highly exothermic. An organic solvent, for example acetonitrile or ethanol, is preferably added in Step i) to inhibit the reaction rate. The molar ratio of water to long-chain alkyl containing dialkoxysilane is preferably greater than 0.5:1, especially greater than 2:1, for example greater than 3:1, greater than 5:1. The reaction of Step i) is suitably carried out for 1-8 h, for example 3-6 h. In Step i), Catalyst 3 is generally an acidic catalyst, for example concentrated sulfuric acid or hydrochloric acid. In Step ii), the by-products, mainly small molecular alcohols, are usually removed by distillation; Catalyst 3 can be removed for example by neutralization with alkaline substances; organic solvents can be removed by rinsing or distillation in case an organic solvent is added in Step i). In an embodiment herein, the oligomer of Formula II or Ill is prepared by the process comprising steps: i) adding water dropwise to long-chain alkyl containing dialkoxysilane in the presence of Catalyst 3 such as hydrochloric acid and an organic solvent such as ethanol to carry out reaction, and the molar ratio of water to long-chain alkyl containing dialkoxysilane is greater than 2:1; ii) removing by-products, water, organic solvent and Catalyst 3.

In Step (a), the organosilicon compound B) can be selectively added according to the structure of the desired hydrogenpolyorganosiloxane, generally added in the process for synthesizing poly-hydrogen polyorganosiloxane. The organosilicon compound B) can be a dialkoxysilane or linear oligomer thereof of Formula IV, or a cyclic oligomer of dialkoxysilane of Formula V.

In Step (b), the endcapper is typically of Formula VII:

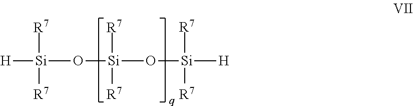

where R⁷ is independently at each occurrence a C1-C5 alkyl, for example methyl, ethyl, propyl, butyl, pentyl, preferably methyl;

q is an arbitrary number between 0 and 20, for example 0, 3, 6, 9, 12, 15, 18.

In Step (b), the reaction is typically an equilibration reaction, which is carried out suitably at a temperature of from 100° C. to 140° C., especially at a temperature of from 110° C. to 130° C., for a period of suitably from 3 h to 8 h. Generally, the longer the equilibration reaction proceeds, the more uniform the reaction tends to be. However, the above reaction time is preferred for economic consideration.

In an embodiment herein, the endcapper has a structural formula as shown in Formula VII, where R⁷ is methyl and q is 0. Considering the endcapper in this embodiment is in gaseous state at the reaction temperature of Step (b) and needs to be refluxed due to its low boiling point, an oligomer of Formula VII where q≥1 is preferred to act as the endcapper for easy operation.

In Step (a) and (b), the amounts of the hydroxyl-terminated polysiloxane, organosilicon compound A) and B), and the endcapper can be selected according to the number of M and D structure units in the desired hydrogenpolyorganosiloxane.

In Step (a), Catalyst 1 is preferably an acidic catalyst, for example phosphonitrilic chloride, trifluoromethanesulfonic acid, and acidic ion exchange resin. Catalyst 1 should be used in a minimum amount required to ensure effective condensation and equilibration reaction. In Step (b), Catalyst 2 is preferably an acidic catalyst, specifically as described above. Catalyst 2 should be used in a minimum amount required to ensure an effective equilibration reaction. In order to avoid the introduction of more catalyst impurities that are more difficult to remove subsequently, Catalyst 2 is preferably the same as Catalyst 1. In this case, to simplify the feeding operation, Catalyst 2 in Step (b) can be fed together with Catalyst 1 in Step (a). The catalyst of the present disclosure is preferably phosphonitrilic chloride.

In Step (a) and (b), the reactions are suitably carried out in the absence of water, and further in the absence of water and a solvent. The term “in the absence of” herein means that water or a solvent is present in the reaction system in an amount of lower than 0.1 wt %, for example, lower than 0.05 wt %.

The preparation method of the present disclosure can further comprise Step (c) of removing the catalysts to minimize the effect of catalyst impurities on product performance. Generally, acidic catalysts are neutralized with alkaline substances. Considering that Si—H group would convert into Si—OH group in the presence of a strong alkaline substance, preference is given to weak alkaline substances for example sodium carbonate, sodium bicarbonate, magnesium oxide, and zinc oxide to neutralize the catalyst of the present disclosure. The temperature and time for neutralization can be selected according to the specific catalyst and alkaline substance combining economic consideration.

In the present disclosure, Step (a), (b) and (c) are advantageously performed in the presence of an inert atmosphere, that is usually a nitrogen or argon atmosphere.

The preparation process of the present disclosure also comprises Step (d) of removing low boilers, including small molecular cyclosiloxanes, small molecular alcohol, water, and unreacted organosilicon compound A) and B), preferably by vacuum distillation at a suitable pressure below 100 mbar, for example below 60 mbar, and at a suitable temperature of from 140° C. to 190° C., for example, from 160° C. to 180° C.

The third aspect of the present disclosure also provides use of the hydrogenpolyorganosiloxane according to the first aspect of the present disclosure in thermally conductive silicone compositions, especially silicone compositions with a high loading of thermally conductive fillers.

Non-limiting examples of suitable thermally conductive fillers include metals (such as aluminum, copper, nickel, gold, silver, gallium, indium, and silicon), metal oxides (such as alumina, zinc oxide, magnesium oxide, titanium oxide, iron oxide, chromium oxide, zirconium oxide, and silicon dioxide), metal nitrides (such as boron nitride, aluminum nitride, and silicon nitride), metal carbides (such as boron carbide and silicon carbide) and non-metals (such as graphite and graphene). In an embodiment herein, the thermally conductive filler comprises alumina. In another embodiment herein, the thermally conductive filler comprises alumina and zinc oxide.

The average particle size of thermally conductive filler is not particularly limited, but it preferably ranges from 0.1 to 120 μm, further from 0.1 to 50 μm. In an embodiment herein, the thermally conductive filler comprises Filler i) a thermally conductive filler having an average particle size of greater than or equal to 20 μm, and Filler ii) a thermally conductive filler having an average particle size of less than 20 μm. In another embodiment herein, the thermally conductive filler comprises Filler i) a thermally conductive filler having an average particle size of greater than or equal to 20 μm and less than or equal to 100 μm, for example, greater than 30 μm and less than or equal to 60 μm, and Filler ii), a thermally conductive filler having an average particle size of greater than or equal to 0.1 μm and less than 20 μm, for example, greater than or equal to 1 μm and less than or equal to 10 μm. In any of the above embodiments, the mass ratio of Filler i) to Filler ii) is suitably in the range of from 0.3:1 to 5:1, for example, from 0.3:1 to 2:1.

The hydrogenpolyorganosiloxane according to the first aspect of the present disclosure is particularly advantageously capable of lowering the viscosity of the resulting silicone composition at a high loading of thermally conductive fillers, thereby improving thermal conductivity. The high loading level of thermally conductive fillers can be determined by those skilled in the art according to the density of the specific thermally conductive filler and its compatibility with the polyorganosiloxane, and generally vary with the type of thermally conductive fillers. For example, for an alumina filler, an amount of from 88 wt % to 93 wt % based on the total weight of thermally conductive silicone composition can be regarded as a high loading; for a boron nitride filler, an amount of from 50 wt % to 60 wt % based on the total weight of the composition can be regarded as a high loading; and, however, for a graphite filler, an amount of 20 wt % based on the total weight of the composition can be regarded as a high loading. In an embodiment herein, the thermally conductive filler comprising alumina, or alumina and zinc oxide, is used in an amount of from 88 wt % to 93 wt % based on the total weight of the thermally conductive silicone composition.

The fourth aspect of the present disclosure provides a thermally conductive silicone composition comprising:
a) at least one hydrogenpolyorganosiloxane according to the first aspect of the present disclosure, and
b) at least one thermally conductive filler according to the third aspect of the present disclosure.

The composition may further comprise c) at least one organopolysiloxane containing at least two silicon-bonded alkenyl groups per molecule. The position of the alkenyl groups is not particularly limited, and they can be present only as side groups, or as both side groups and end groups. The organopolysiloxane c) is typically consisting essentially of units selected from R^{a}R^{b}₂SiO_{1/2}, R^{b}₂SiO_{2/2}, R^{b}₃SiO_{1/2} and R^{a}R^{b}SiO_{2/2}, where R^{a} is independently at each occurrence an alkenyl group having from 2 to 6 carbon atoms, for example vinyl, allyl, propenyl, preferably vinyl; R^{b} is independently at each occurrence a substituted or unsubstituted monovalent organic group having from 1 to 20 preferably 1 to 10 carbon atoms, for example alkyl, aryl or alkaryl, preferably methyl and phenyl, more preferably methyl.

The composition may further comprise d) hydrosilylation catalyst, which can be a variety of hydrosilylation catalysts used in the prior arts for addition-curing silicone rubber, preferably platinum-based catalyst, for example chloroplatinic acid, chloroplatinates, olefin complexes of platinum, and alkenylsiloxane complexes of platinum. The platinum-based catalyst can be used in an amount subject to the desired curing rate and economic consideration, which is usually a minimum level required to ensure an effective hydrosilylation reaction.

The composition may further comprise e) inhibitor, which can be a variety of inhibitors used in the art, for example acetylenic alcohol such as 1-ethynyl-1-cyclohexanol, 2-methyl-3-butyn-2-ol; polylvinylsiloxanes such as 1,3,5,7-tetravinyltetramethyltetracyclo-siloxane; alkyl maleate. The amount of the inhibitor can be selected according to its chemical structure and the desired curing rate.

In an embodiment herein, the thermally conductive silicone composition comprising:
a) at least one hydrogenpolyorganosiloxane according to the first aspect of the present disclosure,
b) at least one thermally conductive filler according to the third aspect of the present disclosure,
c) at least one organopolysiloxane containing at least two silicon-bonded alkenyl groups per molecule as defined above, and
d) the aforesaid hydrosilylation catalyst, and
e) optionally, the aforesaid inhibitor.

The composition may further comprise other components, for example filler surface treatment agents, diluents and plasticizers, as long as such components do not impair the effects of the present invention.

### DETAILED DESCRIPTION OF THE PREFERRED EMBODIMENTS

The present invention is further illustrated by the following examples, but is not limited to the scope thereof. Any experimental methods with no conditions specified in the following examples are selected according to the conventional methods and conditions, or product specifications.

### Characterization of Molecular Structure

¹H NMR spectroscopy
Test solvent: deuterated chloroform (TMS-free)
Spectrometer Bruker Avance Ill HD 400
Sampling head: 5 mm BBO probe

Measured Parameters:
Pulse sequence (Pulprog)=zg30
TD=65536
NS=64
SW=18 ppm
AQ=4.54 s
D1=5 s

Some measurement parameters may need to be adjusted appropriately depending on the type of spectrometer.

²⁹Si NMR Spectroscopy

Test solvent: deuterated benzene (containg relaxation reagent chromium acetylacetonate and no internal standard substance added)
Spectrometer Bruker Avance III HD 400
Sampling head: 5 mm BBO probe

Measured Parameters:
Pulse sequence=zgig60
TD=65536
NS=2048
SW=200 ppm
AQ=2.04 s
D1=5 s

Some measurement parameters may need to be adjusted appropriately depending on the type of spectrometer.

### Characterization of Molecular Weight Distribution

PSS SECcurity gel permeation chromatography is used to separate silane hydrolyzed oligomers with different degrees of polymerization, and each molecular weight is determined by comparison with the reference. Tetrahydrofuran is used as the solvent, and PLgel 5 um guard and PLgel 5 um 100 A provided by Agilent are used as the columns. The temperature of the column oven is 45° C., the feed rate is 1 ml/min, and the injection volume is 20 μl.

### Determination of Viscosity of the Polymer

The viscosities of hydrogenpolyorganosiloxanes or hydrogen-terminated polydimethylsiloxanes are measured by Brookfield viscometer using a No. 3 spindle at 25° C. and 300 rpm for 30 s.

### Determination of Viscosity of the Composition

It is carried out in accordance with DIN EN ISO 3219: Determination of viscosity of polymers and resins in the liquid state or as emulsions or dispersions using a rotational viscometer with defined shear rate (ISO 3219:1993).

The raw materials used in the Examples are all commercially available, with detailed information as follows:
Hydroxyl-terminated polydimethylsiloxane, WACKER® FINISH WS 62 M, having a dynamic viscosity of 50-110 mPa·s, measured at 25° C. according to DIN 51562, supplied by Wacker Chemicals;
Phosphonitrilic chloride, WACKER® PNCL 2/100 PERCENT, supplied by Wacker Chemicals;
1,1,3,3-tetramethyldisiloxane, supplied by Guike New Material;
Alumina A, spherical alumina powder having an average particle size of 40 μm;
Alumina B, spherical alumina powder having an average particle size of 5 μm;
Zinc oxide, non-spherical zinc oxide powder having an average particle size of 5 μm;
Hydrogen-terminated polydimethylsiloxane C1, XJY-707, having a dynamic viscosity of 145 mPa·s at 25° C., supplied by Xinjiayi New Material, referred to as H Polymer C1 thereafter;
Hydrogen-terminated polydimethylsiloxane C2, having a dynamic viscosity of 85 mPa·s at 25° C., supplied by Wacker Chemicals, referred to as H Polymer C2 thereafter;
Hydrogen-terminated polydimethylsiloxane C3, having a dynamic viscosity of 1,040 mPa·s at 25° C., supplied by Wacker Chemicals, referred to as H Polymer C3 thereafter.

### Synthesis Example 1

68.5 g of dodecyl diethoxymethylsilane, 110 g of ethanol and 1.22 g of 5% hydrochloric acid aqueous solution were added to a flask at room temperature, stirred, then 25 g of water was added dropwise to the flask to carry out reaction at room temperature for 4 h and then was subject to 65° C. for 1 h to give a white solid precipitate. Afterwards the precipitate was transferred to a distillation flask, which was subjected to rotary evaporation at 85° C. and 100 mbar for 1 h to give oligomers of hydrolyzed dodecyl diethoxymethylsilane. As determined by NMR, the oligomers comprise 53.60 wt % of trimethyltridodecylcyclotisiloxane D₃^{C12H5}, 18.17 wt % of tetramethyltetradodecylcyclotetrasiloxane D₄^{C12H25}, 6.83 wt % of CH₃(OR)(C₁₂H₂₅)SiO_{1/2} unit (wherein R is —C₂H₅ or H, mainly —C₂H₅) and 21.40 wt % of CH₃(C₁₂H₂)SiO_{2/2} unit and cyclic pentamer, cyclic hexamer and cyclic oligomers with higher polymerization degrees. As determined by GPC, the oligomers comprise 52.17 wt % of trimer, 18.75 wt % of tetramer, 6.36 wt % of pentamers and 22.73 wt % of hexamer and oligomers with higher polymerization degrees.

### Synthesis Example 2

500 g of hydroxyl-terminated polydimethylsiloxane, 28.9 g of octyldimethoxymethyl-silane and 0.135 g of phosphonitrilic chloride were added to a flask, stirred, and heated to 100° C. to carry out reaction at 100° C. and 50 mbar for 0.5 h with nitrogen flow. Then 11.26 g of 1,1,3,3-tetramethyldisiloxane was added to the flask and heated to 120° C. to react for 5 h. Upon completion of the reaction, sodium carbonate solid was added to treat phosphonitrilic chloride at 50° C. for 1.5 h, and then was filtered. Afterwards the resulting reactant was transferred to a distillation flask, distilled at 170° C. and 30 mbar for 1.5 h to remove low boilers, and cooled to room temperature to give a hydrogenpolyorganosiloxane, referred to as H Polymer 1, of the following structural formula with a dynamic viscosity of 140 mPa·s at 25° C.

(H(CH₃)₂SiO)_{1.67}((CH₃)₂SiO)_{74.25}((CH₃)(C₈H₁₇)SiO)_{1.51}(Si(CH₃)₂(OH))_{0.05}(Si(CH₃)₂(OCH₃))_{0.28}

### Synthesis Example 3

200 g of hydroxyl-terminated polydimethylsiloxane, 30.8 g of the oligomers of hydrolyzed dodecyl diethoxymethylsilane obtained by Synthesis Example 1 and 0.0592 g of phosphonitrilic chloride were added to a flask, stirred, and heated to 95° C. to carry out reaction at 95° C. and 50 mbar for 0.5 h with nitrogen flow. Then 6 g of 1,1,3,3-tetramethyldisiloxane was added to the flask and heated to 120° C. to react for 5 h. Upon completion of the reaction, sodium carbonate solid was added to treat phosphonitrilic chloride at 50° C. for 1.5 h, and then was filtered. Afterwards the resulting reactant was transferred to a distillation flask, distilled at 170° C. and 30 mbar for 1.5 h to remove low boilers, and cooled to room temperature to give a hydrogenpolyorganosiloxane, referred to as H Polymer 2, of the following structural formula with a dynamic viscosity of 95 mPa·s at 25° C.

(H(CH₃)₂SiO)_{1.88}((CH₃)₂SiO)_{60.95}((CH₃)(C₁₂H₂₅)SiO)_{3.02}(Si(CH₃)₂(OH))_{0.09}(Si(CH₃)₂(OC₂H₅))_{0.03}

### Synthesis Example 4

220 g of hydroxyl-terminated polydimethylsiloxane, 7.7 g of the oligomers of hydrolyzed dodecyl diethoxymethylsilane obtained by Synthesis Example 1 and 0.0573 g of phosphonitrilic chloride were added to a flask, stirred, and heated to 95° C. to carry out reaction at 95° C. and 50 mbar for 0.5 h with nitrogen flow. Then 1.5 g of 1,1,3,3-tetramethyldisiloxane was added to the flask and heated to 120° C. to react for 5 h. Upon completion of the reaction, sodium carbonate solid was added to treat phosphonitrilic chloride at 50° C. for 1.5 h, and then was filtered. Afterwards the resulting reactant was transferred to a distillation flask, distilled at 170° C. and 30 mbar for 1.5 h to remove low boilers, and cooled to room temperature to give a hydrogenpolyorganosiloxane, referred to as H Polymer 3, of the following structural formula with a dynamic viscosity of 1,155 mPa·s at 25° C.

(H(CH₃)₂SiO)_{1.63}((CH₃)₂SiO)_{241.14}((CH₃)(C₁₂H₂₅)SiO)_{3.78}(Si(CH₃)₂(OH))_{0.35}(Si(CH₃)₂(OC₂H₅))_{0.02}

According to table 1, H Polymer 1-3 and H Polymer C1-C3 were mixed with thermally conductive fillers respectively, and the viscosities of the resulting compositions were measured at shear rates of 1 s⁻¹ and 10 s⁻¹.

TABLE 1

| | Composition | Composition | Composition | Composition | Composition | Composition |
|---|---|---|---|---|---|---|
| Components/g | 1 | C1 | 2 | C2 | 3 | C3 |
| H Polymer 1 | 10 | / | / | / | / | / |
| H Polymer C1 | / | 10 | / | / | / | / |
| H Polymer 2 | / | / | 10 | / | / | / |
| H Polymer C2 | / | / | / | 10 | / | / |
| H Polymer 3 | / | / | / | / | 10 | / |
| H Polymer C3 | / | / | / | / | / | 10 |
| Alumina A | 25 | 25 | 25 | 25 | 25 | 25 |
| Alumina B | 36 | 36 | 36 | 36 | 36 | 36 |
| Zinc oxide | 29 | 29 | 29 | 29 | 29 | 29 |

Viscosity of Composition/mPa · s

| | | | | | | |
|---|---|---|---|---|---|---|
| D = 1 s⁻¹ | 1,200,000 | 1,615,000 | 819,500 | 963,000 | 2,940,000 | 4,245,000 |
| D = 10 s⁻¹ | 248,000 | 306,000 | 256,000 | 319,000 | 407,000 | 560,000 |

Table 1 shows that H Polymer 1-3 are more effective in lowering the viscosity of the composition than corresponding H Polymer C1-C3 with similar viscosities at the same thermally conductive filler loading, thereby improving the thermal conductivity of the composition. H Polymer 2-3, having higher viscosities than the corresponding H Polymer C2-C3, perform better in lowering the viscosity of the composition, due to the function of an appropriate content of alkoxy and hydroxyl groups and also a larger number of long-chain alkyls introduced.

According to table 2, H Polymer 1-3 and H Polymer C1-C3 were mixed with thermally conductive fillers respectively, and the viscosities of the resulting compositions were measured at shear rates of 1 s⁻¹ and 10 s⁻¹.

TABLE 2

| | Composition | Composition | Composition | Composition | Composition | Composition |
|---|---|---|---|---|---|---|
| Components/g | 4 | C4 | 5 | C5 | 6 | C6 |
| H Polymer 1 | 10 | / | / | / | / | / |
| H Polymer C1 | / | 10 | / | / | / | / |
| H Polymer 2 | / | / | 10 | / | / | / |
| H Polymer C2 | / | / | / | 10 | / | / |
| H Polymer 3 | / | / | / | / | 10 | / |
| H Polymer C3 | / | / | / | / | / | 10 |
| Alumina A | 60 | 60 | 60 | 60 | 60 | 60 |
| Alumina B | 30 | 30 | 30 | 30 | 30 | 30 |

Viscosity of Composition/mPa · s

| | | | | | | |
|---|---|---|---|---|---|---|
| D = 1 s⁻¹ | 65,100 | 135,000 | 13,300 | 40,200 | 133,500 | 253,000 |
| D = 10 s⁻¹ | 33,000 | 55,700 | 11,600 | 23,200 | 126,000 | 183,000 |

Table 2 shows that H Polymer 1-3 are more effective in lowering the viscosity of the composition than corresponding H Polymer C1-C3 with similar viscosities at the same thermally conductive filler loading, thereby improving the thermal conductivity of the composition.

Table 3 lists the viscosity changes of H Polymer 1-3 after being left at room temperature for 10 months. The viscosity changes are within ±5%, showing a good storage stability.

TABLE 3

| | Initial | Viscosity after 10M | |
|---|---|---|---|
| | viscosity | at room temperature | Viscosity |
| | (mPa · s) | (mPa · s) | change |
| H Polymer 1 | 140 | 133 | −5% |
| H Polymer 2 | 95 | 95 | 0% |
| H Polymer 3 | 1,155 | 1,190 | +3% |

1-17. (canceled)

18. A hydrogenpolyorganosiloxane having structural formula as shown in Formula I: 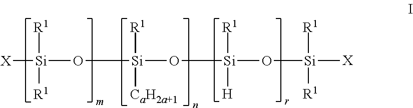
where a is an arbitrary integer between 6 and 18,
n is an arbitrary number between 0.7 and 30,
m is an arbitrary number between 10 and 1500,
r is an arbitrary number between 0 and 200,
R¹ is independently at each occurrence a C1-C5 alkyl or phenyl, and
X represents one or more groups selected from among hydrogen, alkoxy and hydroxyl, and greater than or equal to 60 mol % of X based on the total number of moles of the X groups are hydrogen atoms.

19. The hydrogenpolyorganosiloxane of claim 18, wherein greater than or equal to 60 mol % and less than 100 mol % of X based on the total number of moles of the X groups are hydrogen atoms.

20. The hydrogenpolyorganosiloxane of claim 18, wherein greater than 0 mol % and less than or equal to 30 mol % of X based on the total number of moles of the X groups are alkoxy and/or hydroxyl groups.

21. The hydrogenpolyorganosiloxane of claim 18, wherein greater than or equal to 80 mol % and less than 100 mol % of X are hydrogen atoms and greater than 0 mol % and less than or equal to 20 mol % of X are alkoxy and/or hydroxyl groups, based on the total number of moles of the X groups.

22. The hydrogenpolyorganosiloxane of claim 18, wherein n is an arbitrary number between 3 and 15.

23. The hydrogenpolyorganosiloxane of claim 18, wherein m is an arbitrary number between 50 and 500.

24. The hydrogenpolyorganosiloxane of claim 18, wherein a is an arbitrary integer between 6 and 16.

25. The hydrogenpolyorganosiloxane of claim 18, wherein a dynamic viscosity of from 10 to 3000 mPa·s at 25° C.

26. A method of preparing the hydrogenpolyorganosiloxane of claim 18, comprising:
a) reacting together a hydroxyl-terminated polysiloxane and at least one organosilicon compound A) selected from among compounds of Formula II and III, and optionally at least one organosilicon compound B) selected from among compounds of Formula IV and V, in the presence of Catalyst 1, 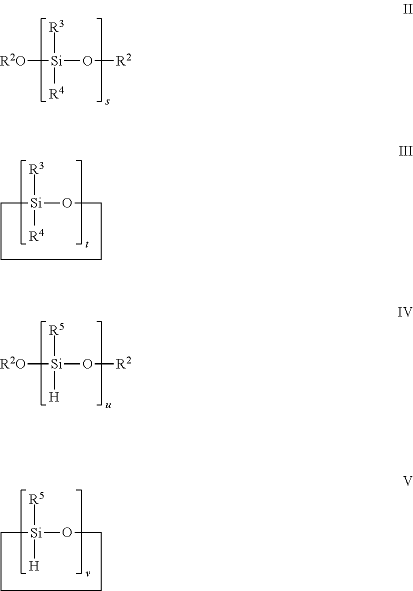
where R² is independently at each occurrence a methyl, ethyl or hydrogen,
R³ is independently at each occurrence a C6-C18 alkyl,
R⁴ is independently at each occurrence a C1-C5 alkyl,
R⁵ is independently at each occurrence a C1-C5 alkyl,
s is an arbitrary number between 1 and 20,
t is an arbitrary number between 3 and 20,
u is an arbitrary number between 1 and 100,
v is an arbitrary number between 3 and 100; and
b) reacting the product of Step (a) with an endcapper in the presence of Catalyst 2 to give the hydrogenpolyorganosiloxane.

27. The method of claim 26, wherein the hydroxyl-terminated polysiloxane in Step (a) is of Formula VI: 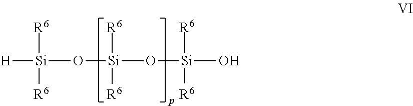
where R⁶ is independently at each occurrence a C1-C5 alkyl or phenyl, and
p is an arbitrary number between 10 and 100.

28. The method of claim 26, wherein the reaction of Step (a) is carried out at a temperature of from 80° C. to 110° C.

29. The method claim 26, wherein the endcapper in Step (b) is of Formula VII: 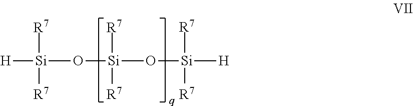
where R⁷ is independently at each occurrence a C1-C5 alkyl, and
q is an arbitrary number between 0 and 20.

30. The method of claim 26, characterized in that the reaction of Step (b) is carried out at a temperature of from 100° C. to 140° C.

31. The method of claim 26, characterized in that both Catalyst 1 and Catalyst 2 are phosphonitrilic chloride.

32. Use of the hydrogenpolyorganosiloxane of claim 18 in thermally conductive silicone compositions.

33. The use of claim 32, wherein the thermally conductive fillers used in the compositions comprise alumina.

34. The use of claim 33, wherein the thermally conductive fillers are used in an amount of from 88 wt % to 93 wt % based on the total weight of the composition.
